(19) United States
(12) Patent Application Publication
(10) Pub. No.: US 2024/0123500 A1
(43) Pub. Date: Apr. 18, 2024

(54) POROUS SINTERED BODIES AND METHODS OF PREPARING POROUS SINTERED BODIES

(71) Applicant: ENTEGRIS, INC., Billerica, MA (US)

(72) Inventors: Thines Kumar Perumal, Singapore (SG); Subhash Guddati, Singapore (SG); Virendra Warke, North Chelmsford, MA (US); Devon Nichole Dion, Nashua, NH (US); Montray Leavy, Singapore (SG)

(21) Appl. No.: 18/379,290

(22) Filed: Oct. 12, 2023

Related U.S. Application Data
(60) Provisional application No. 63/416,391, filed on Oct. 14, 2022.

(51) Int. Cl. B22F 10/18; B22F 10/20; B22F 12/50; B33Y 10/00; B33Y 70/00; B33Y 80/00

(52) U.S. Cl. CPC B22F 10/18; B22F 10/20; B22F 12/50; B33Y 10/00; B33Y 70/00; B33Y 80/00; B22F 2304/10

(57) ABSTRACT

Described are porous sintered bodies and methods of making porous sintered bodies by additive manufacturing methods.

### FIELD

The described disclosure relates to porous sintered bodies and methods and compositions for forming porous sintered bodies by additive manufacturing methods.

### BACKGROUND

Porous, sintered bodies find uses in a variety of industrial applications, including for filtering of materials used in the microelectronics and semiconductor manufacturing industries, as well as other industries that require highly pure materials for processing. For example, in the semiconductor and microelectronics industries, in-line filters made of porous sintered membranes are often used to remove contaminants from fluids to prevent introduction of the contaminant into a manufacturing process. The fluid may be in the form of a gas or a liquid.

Currently, common commercial methods of preparing porous sintered bodies include forming a green body using a mold and compaction (e.g., by an “isotactic molding technique”) to form a compacted “green body” precursor, followed by a step of sintering the compacted green body. These techniques are labor intensive and typically require manually handling and moving the green body, which is fragile. The methods can produce significant waste, undesirably low efficiencies, and undesirably high costs.

### SUMMARY

The present description relates to novel and inventive materials and methods for forming porous sintered bodies by an extrusion-based additive manufacturing method.

Certain methods used to prepare porous inorganic (e.g., metal) bodies use a feedstock composition in the form of a powder. The powder may be formed into a shaped body by a compacting or pressing method, such as with a mold, or alternately by a powder-bed additive manufacturing process. Compacting and pressing methods are not able to prepare bodies having complex shapes, and suffer from high costs for low volumes of products due to the expense of producing a mold. Powder bed additive manufacturing processes can be difficult to use because feedstock in the form of a powder can be difficult to handle during steps of spreading the powder into thin layers, may require lengthy processing times for forming a finished body, and can require a significant amount of wasted powder feedstock.

As now described, porous sintered bodies may be prepared by forming a precursor body with an “extrusion-type” additive manufacturing technique, which uses a feedstock in a flowable form, not a dry powder, and which does not require a powder-bed and the formation of multiple layers of powder feedstock. An additive manufacturing apparatus extrudes the flowable feedstock, which contains inorganic particles and binder composition, as individual layers. The layers are extruded to form a multi-layer composite or “precursor body” having a desired size and shape. The precursor body is further processed by an optional curing step, removal of the binder composition, and a sintering step, to form a porous sintered body.

Selecting useful sintering conditions, including a temperature profile, can produce useful or preferred pore size and density of the porous sintered body. These extrusion-type additive manufacturing methods may be effective to: reduce the amount of feedstock waste, lower overall cost of final part, or reduce total time (“printing time”) required to prepare a porous sintered body. The method may be useful for a range of types of metals and other inorganic particle materials, and is able to process feedstock that contains particles in the form of irregular particles (e.g., filament particles, high aspect ratio particles, dendritic particles), fine particles of submicron or nano dimensions, and combinations of two or more of these types of particles in a feedstock. In one aspect, the disclosure relates to a method of forming a porous sintered body by additive manufacturing. The method includes forming a solidified feedstock composite having layers of solidified feedstock by: extruding feedstock that contains inorganic particles and binder composition, forming a feedstock layer by applying the extruded feedstock to a surface, causing the feedstock of the feedstock layer to solidify to form solidified feedstock, forming an additional solidified feedstock layer to an upper surface of the solidified feedstock by extruding the feedstock and applying the feedstock to the upper surface, removing the binder composition from the solidified feedstock composite; and heating the solidified feedstock composite to a temperature that causes inorganic particles of the solidified feedstock composite to become fused together to form a porous sintered body.

In another aspect, the disclosure relates to a method of forming a body by additive manufacturing. The method includes: extruding feedstock that contains binder composition and inorganic particles, the inorganic particles being present in an amount in a range from 15 to 50 percent by volume of the feedstock; applying the extruded feedstock to a surface to form a feedstock layer having an upper surface; causing the feedstock of the feedstock layer to solidify to form a solidified feedstock layer; then extruding the feedstock and applying the feedstock to the upper surface of the solidified feedstock layer to form an additional feedstock layer on the upper surface.

In yet another aspect, the disclosure relates to porous sintered body that includes: multiple layers of extruded inorganic particles fused together to form a porous matrix of interconnected inorganic particles. The porous sintered body has: layers having a thickness of from 30 to 200 microns, a porosity of at least 40 percent, and staircase structures on surfaces of the sintered porous bodies.

In yet another aspect, the disclosure relates to feedstock capable of being processed by extrusion-type additive manufacturing to form a porous sintered body. The feedstock includes binder composition and inorganic particles, the inorganic particles being present in an amount in a range from 15 to 50 percent by volume of the feedstock.

### BRIEF DESCRIPTION OF THE DRAWING

FIGS. 1A, 1B and 1C show examples of sequential steps of an extrusion-type additive manufacturing process as described.

FIGS. 2 and 3 show examples of dendritic Nickel 255 particles and fibrous stainless steel particles, respectively, useful in compositions and methods as described.

### DETAILED DESCRIPTION

According to the following description, a porous sintered body can be prepared by a series of steps that includes an extrusion-type additive manufacturing step to form a precursor body that can be further processed to form a porous sintered body. According to example methods, an extrusion-type additive manufacturing step is used to form a precursor body that includes multiple extruded layers of solidified feedstock, and the precursor body can then be further processed by steps that include a sintering step to form a porous sintered body.

Several different varieties of additive manufacturing techniques are known. Specific examples include those that are referred to as “binder jet printing,” “stereolithography,” and “selective laser sintering,” among others. These techniques are known to be effective for producing various types of “printed” objects, with the different techniques having various advantages and disadvantages when forming articles having different physical properties, e.g., dense versus porous objects, or metal versus polymeric bodies, etc.

As described herein, additive manufacturing techniques referred to as “extrusion-type” additive manufacturing techniques have been identified as having certain advantages when used to form printed objects that are porous, and that include sintered inorganic particles. These objects, sometimes referred to as “porous sintered bodies” or “porous inorganic sintered bodies,” generally are bodies that include an interconnected matrix formed of sintered inorganic particles, with open spaces (“pores”) located between the interconnected particles to allow fluid (e.g., gas) to flow through the body.

According to extrusion-type additive manufacturing techniques generally, a feedstock in the form of a flowable liquid or paste contains inorganic particles and a binder composition that can be hardened or “solidified” to form a precursor body. The binder composition includes at least a material that can be hardened or solidified after the feedstock is extruded, and may contain other optional ingredients such as a solvent or “pore formers,” among others. The flowable feedstock can be formed into a precursor body by applying a first extruded layer of the feedstock to a surface, then applying another extruded layer of the feedstock onto the first extruded layer, followed by applying multiple subsequent extruded layers of the feedstock onto additional subsequently-formed layers of the feedstock, i.e., by applying layer-after-layer of extruded feedstock onto previously-formed layers to form a multi-layer precursor body made of the multiple extruded layers of solidified feedstock. Each subsequent layer is formed on an upper surface of a previously-formed extruded layer of feedstock, and each layer is formed by extruding the feedstock from a “printhead,” nozzle, or other extrusion port, then allowing the extruded feedstock to solidify as described herein to form a “solidified feedstock layer.”

The feedstock when extruded is in a form of a flowable liquid that contains inorganic particles in combination with binder composition that is capable of being hardened (i.e., “solidified”) after being extruded to form a portion of a precursor body that can be further processed to form a sintered porous inorganic body.

When used to form porous inorganic sintered bodies, extrusion-type additive manufacturing processes have been found to offer advantages relative to other types of additive manufacturing process, particularly over additive manufacturing techniques that involve the use of feedstock in the form of a powder, and the use of a “powder bed” that requires the formation of many individual layers of powder feedstock, portions of which are selectively solidified to form layers of a solidified feedstock body. Each layer of powder must be uniformly formed, and each layer-formation step must be efficient, meaning that the powder feedstock must be easily and consistently formed into an even thin layer of powder within the powder bed, in a commercially useful timeframe.

Depending on the amount and type of particles in a feedstock, the types and amounts of other ingredients in a powder feedstock, the repeated step of consistently and uniformly forming a uniform layer of feedstock may come with significant challenges. Forming uniform layers of a powder feedstock that contains particles that are irregularly-shaped, that have a high aspect ratio, or that are branched or fibrous or dendritic, etc., for a purpose of creating an amount of space between inorganic particles of the feedstock, can be particularly challenging and can cause reduced efficiency and speed of a process. The reduced efficiency or speed of forming layers of powder feedstock as a step of a powder-bed additive manufacturing method results in reduced printing speeds and increase costs.

As another disadvantage, powder bed techniques require a significant amount of extra powder that does not become part of a final part (sintered body) formed in the additive manufacturing method. A portion of each individual layer of powder feedstock that is formed during an additive manufacturing process is selectively solidified to become part of a formed body. But the remaining portion of each feedstock layer, the portion that is not selectively solidified, goes un-used. This need to form multiple layers of powder feedstock, and allowing a significant portion of each layer to remain un-used, increases a total cost of preparing the formed body.

Extrusion-type additive manufacturing techniques avoid the difficulty of forming multiple layers of powder feedstock within a powder bed, and avoid the significant amount of un-used feedstock required by powder bed techniques. According to extrusion-type techniques, steps required to form a precursor body use a flowable liquid feedstock, and do not require forming multiple layers of powder feedstock or selectively solidifying a portion of feedstock within each layer.

According to extrusion-type techniques, feedstock (e.g., a “flowable liquid feedstock” or “liquid feedstock” for short) can contain (comprise, consist of, or consist essentially of) inorganic particles and a binder composition, and is in a flowable (e.g., liquid) state that can be processed or allowed to form a hardened or “solidified” state. The binder composition can include a polymer that can be “solidified” during a step of forming a precursor body, along with optional ingredients that provide desired flow properties, curing properties, or physical or mechanical properties of the feedstock or a feedstock derivative such as a precursor body or a porous sintered body. Examples of optional ingredients include, pore-forming particles, water or organic solvent, surface active agents such as dispersants or surfactants, to form a flowable binder that has flow properties suitable to be formed into a precursor body and subsequently into a porous sintered body.

The flowable feedstock contains at least one component that is flowable, to allow the feedstock to be extruded by passing the feedstock as a liquid, under pressure, through a nozzle or other dispensing orifice. The feedstock may be referred to as a “paste” or a “filament,” and can be handled with the use of an additive manufacturing apparatus to extrude the paste or filament, layer-by-layer, to form a precursor body that has a desired shape and size.

Advantageously, feedstock that can be in a flowable and extrudable form, as opposed to a powder that must be formed into many individual feedstock layers during processing, can be used to form bodies from types of inorganic particles that may be difficult to process using a powder feedstock and powder-bed additive manufacturing techniques. Certain types of inorganic particles can be difficult to process in the form of a powder, to form a powder feedstock layer in a powder-bed. The size and shape of inorganic particles of a powder feedstock can have an effect on handling and flow properties of the powder feedstock, which can cause difficulties or may prevent using the feedstock to form uniform layers of feedstock as needed for powder-bed types of additive manufacturing techniques.

Examples of inorganic particles that may be difficult to use in a powder feedstock or that may not be capable of being used in a powder feedstock include particles that have a high aspect ratio; that are irregularly shaped, such as branched or “dendritic” particles and “filament”-type particles; that have relatively small average particles size (including spherical or low aspect ratio particles that may be metal or ceramic); combinations of different types of particles in a single feedstock (e.g., irregular particles (filament-type or dendritic or high aspect ratio particles) with spherical particles), and particles that have a bi-modal or a tri-modal particle size distribution.

Inorganic particles that are dendritic, and particles that have a high aspect ratio, can have reduced flow properties when included in a powder feedstock. A powder feedstock that contains these types of particles may agglomerate or form clumps and may not be easily formed into a thin uniform feedstock layer as is needed for powder-bed additive manufacturing techniques.

Also, particles of certain sizes, e.g., particles having an average size (D50) less than 10 microns, when included in a powder feedstock, can exhibit difficult flow properties or may be otherwise difficult to form into a thin layer within a powder bed. Particles of these sizes as part of a powder may be prone to static charge buildup or reduced flow properties, especially in the presence of humidity. Particles in this size range may be difficult to use in a powder-bed additive manufacturing techniques.

By using an extrusion-type additive manufacturing technique and a flowable feedstock, inorganic particles that may be difficult to use or that may not be used with a powder feedstock, in a “powder-bed”-type additive manufacturing process, can be formed into a flowable liquid feedstock that can be extruded to form a precursor body, and subsequently processed to form a porous inorganic sintered body.

Extrusion-type additive manufacturing methods involve additive steps that individually and sequentially form multiple layers of extruded feedstock that contain inorganic particles dispersed in binder composition. Using a series of additive steps, multiple layers of solidified feedstock are formed into a precursor body, which is in the form of a multi-layer composite body made from multiple layers of solidified feedstock, each layer formed separately. The precursor body (multi-layer composite) contains inorganic particles dispersed and held in place together by the solidified binder composition.

The precursor body can be further processed to form a porous sintered body. In an optional step, the precursor body may be processed to further cure or further harden the binder composition. Also, in any desired order, or in a single step, the components of the binder composition may be removed from the precursor body to leave behind the inorganic particles, and the inorganic particles may be processed by a sintering step to cause the inorganic particles to fuse or bond together to form an interconnected porous inorganic particle matrix, i.e., a porous sintered body. The resultant porous sintered body comprises (or consists of or consists essentially of) a solid (e.g., rigid or semi-rigid) matrix of fused and thereby interconnected inorganic particles that define an open-cell porous structure. The matrix is porous (e.g., highly porous), with the particles of the matrix having become connected together or “fused” at adjacent surfaces during a sintering step.

The porous sintered body can have a relatively high porosity, particularly relative to previous sintered bodies that are prepared by other additive manufacturing techniques. Example porous sintered bodies as described can be prepared to have a porosity that is effective for the sintered body to be used as a filter for removing particles or other contaminants from a very high purity fluid (e.g., gas or liquid), such as a fluid that is used to manufacture electronic devices, microelectronic devices, or semiconductor materials. Example porosities may be at least 40 percent, e.g., in a range from 50 percent up to or excess of 60, 70, 75, or 80 percent by volume.

As used herein, and in the art of porous sintered bodies, a “porosity” of a porous sintered body (also sometimes referred to as “void fraction”) is a measure of the void (i.e. “empty”) space in the body as a percent of the total volume of the body, and is calculated as a fraction of the volume of the body that is open space (“void” space) over the total volume of the body. A body that has zero percent porosity is completely solid.

A related measurement of a porous body of the present description or a precursor thereof, e.g., a precursor body or solidified feedstock that exists during an extrusion-type additive manufacturing process, is the amount (percent) by volume of inorganic particles in a composition or structure as described. An amount of inorganic particles per total volume of a structure or composition is a percent by volume of the inorganic particles in the composition or structure per total volume of the composition or structure. The portion of the total volume of the composition or structure that does not contain inorganic particles may or may not contain another material such as binder composition used during an additive manufacturing step in any form (e.g., solid, liquid, cured, uncured). For a finished porous sintered body (with an assumption of no residue remaining on surfaces of the porous sintered body), the value of the porosity (in percent) of the sintered body plus the value of the percent volume of inorganic particles of the sintered body is 100 (percent).

Example feedstock compositions, precursor bodies, and porous sintered bodies of the present description may contain an amount of inorganic particles, as a percent of volume of the body, that is below 50 percent, e.g., that is in a range of from 20 to 50 percent volume of inorganic particles based on total volume of the composition or body. As used herein to calculate percent volume of inorganic particles in a composition or structure, the total volume of the composition or structure is taken as the nominal or “bulk” volume of the composition or structure. For example, a nominal or bulk volume of a solidified feedstock layer is the area of the layer multiplied by the thickness of the layer.

The porous sintered body can be in any form. Example shapes for filtration membranes can be as a block or a thin membrane that may have any useful form and shape, e.g., a flat sheet, e.g., a substantially planar, essentially two-dimensional (having a very small thickness) single piece flat sheet or membrane. However, additive manufacturing techniques can be applied to the formation of porous sintered bodies to allow for an extremely wide range of new possible shapes and forms that were not possible when using previous methods for preparing porous bodies.

A porous sintered body for use as a filter (of any shape) may typically include two opposed major surfaces and a thickness between the two opposed major surfaces, through which a fluid flows during a filtering or purification step. A thickness of example sintered bodies used as a filter membrane (e.g., a thickness of a disk or cup, or a thickness of a body wall of a tube or cylinder) can be in a range that is effective for use of the porous body as a filter, e.g., that results in desired flow properties such as sufficient flow at a given pressure drop, and filtering properties such as particle retention, while having sufficient strength and structural integrity to be handled, installed, and used as part of a filter system. Examples of useful thicknesses may be in a range from 0.5 to 10 millimeters, e.g., from 1 to 5 millimeters.

Methods of forming a body by an extrusion-type additive manufacturing technique can involve, in general terms, a sequence of multiple individual steps of extruding a liquid feedstock, each step being used to form a single cross-sectional extruded layer of a body, with the multiple steps in sequence being effective to form a body that is a multi-layer composite of individual layers of extruded, solidified feedstock. The feedstock contains inorganic particles along with other ingredients that together are referred to as “binder composition.” The binder composition contains ingredients that are effective to provide flow properties that allow the feedstock to be extruded, and that also allow the feedstock to be solidified to form solidified feedstock of a precursor body.

One ingredient of a binder composition of a feedstock may be a polymer material that can be solidified after being extruded. A polymer material that can be solidified may be referred to as a “polymer binder.” The polymer binder may be a thermoplastic polymer that reversibly melts and solidifies based on temperature. A feedstock that contains thermoplastic polymer may be solid at ambient temperature (e.g., 22 degrees Celsius), may be heated to perform a step of extruding the feedstock, and may be cooled after being extruded to form solidified feedstock.

Another example of a polymer binder ingredient of a feedstock can be a radiation-curable polymer that includes reactive (curable) polymer and a cure system that causes the polymer to irreversibly harden by a chemical reaction, which can be selectively initiated by exposing the feedstock to electromagnetic radiation such an ultraviolet radiation. A feedstock that contains radiation-curable polymer may be liquid at ambient temperature, may be extruded at ambient temperature, may be “solidified” by curing (at least partial curing) while forming a precursor body, and may optionally be further cured in a “secondary cure step” by exposing solidified feedstock of a precursor body to additional electromagnetic radiation, after the precursor body is completed.

Another optional ingredient of a binder composition of a feedstock is an ingredient in the form of solid polymeric particles that reduce a concentration of inorganic particles within a feedstock, produce space between inorganic particles of the feedstock, and eventually increase a level of porosity of a porous sintered body prepared from the feedstock. This type of solid polymeric particle ingredient may be referred to as “pore-forming polymer particles,” or “pore-forming particles.” These solid polymeric particles are in solid form as part of a feedstock, and can act to physically separate inorganic particles within feedstock and within solidified feedstock to create space between the inorganic particles and to distribute the inorganic particles with desired spacing and uniformity throughout feedstock and solidified feedstock.

Pore-forming particles can be of any useful polymer composition (e.g., thermoplastic), can remain in a solid form through an extrusion step, and may be of size that will be useful in combination with inorganic particles also contained in a feedstock. Sizes of pore-forming particles may be in a range of sizes also useful for the inorganic particles of feedstock, such as on a scale of microns, e.g., having an average size (D50 diameter) of less than 100 microns, less than 50 microns, 10 microns, or less than 20 microns, for example in a range from 1 to 20 microns.

A binder composition can additionally contain minor amounts of functional ingredients or additives that allow for or facilitate flow or curing of the polymer binder. These minor ingredients include any of: a flow aid, a surfactant, an emulsifier, a dispersant to prevent particle agglomeration, and an initiator to initiate cure of polymer when exposed to electromagnetic (e.g., ultraviolet) radiation.

The amounts of described ingredients that are included in a feedstock can be any useful amounts. In example feedstock compositions, the amount of particles can be at least 70 or 80 weight percent of the total weight of the feedstock, e.g., in a range from 80 to 95 weight percent inorganic particles based on total weight feedstock. The remaining amount can include ingredients of a “binder composition” as described, including polymeric binder, optional pore former particles, and optional minor ingredients.

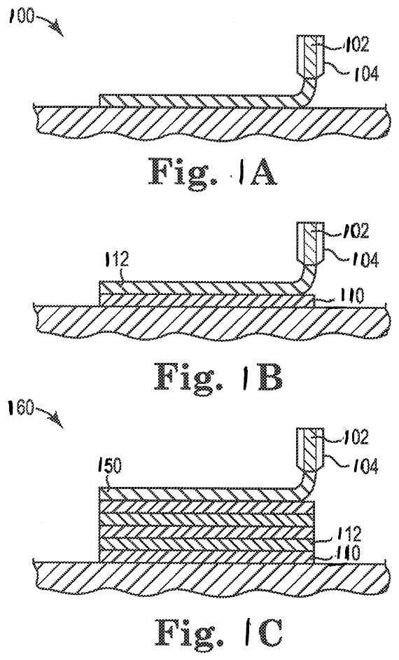

An example of an extrusion-type additive manufacturing technique (100) useful for preparing a multi-layer composite (e.g., a precursor body) as described herein is shown at FIGS. 1A, 1B, and 1C. Feedstock 102 is a flowable (e.g., liquid, high viscosity liquid, or “semi-solid” flowable material) feedstock that contains inorganic particles in combination with binder composition that includes polymer binder that can be solidified to cause the feedstock to be solidified.

The process can be performed using commercially available additive manufacturing equipment and liquid binder polymer combined with the inorganic particles to form a flowable semi-solid feedstock. According to example steps, flowable feedstock (102) is applied as a first feedstock layer by a printhead (e.g., nozzle, extrusion orifice, or other useful device) (104), and is solidified to form a first solidified feedstock layer (110). The feedstock may be solidified by any useful mechanism, depending on the type of polymer binder. If the polymer binder is thermoplastic, the feedstock can be solidified by reducing a temperature of the feedstock. If the polymer binder is chemically curable, the feedstock layer may be solidified by exposing the curable polymer to irradiation or heat that causes the polymer binder to be chemically cured.

In a subsequent step, as shown at FIG. 1B, a second solidified feedstock layer (112) is formed on the first solidified feedstock layer (110). Subsequent steps are used to form a desired number of added layers of solidified feedstock, including a final solidified feedstock layer (150), and to form multi-layer composite (precursor body) 160 (see FIG. 1C). The multi-layer composite (160) may be further processed as desired to form a derivative structure, such as a porous sintered body.

Subsequent processing (or “post-processing”) of the precursor body can include a step to remove the binder composition from the body, sometimes referred to as a “debind” step, and a step to fuse together the inorganic particles, i.e., a “sintering step.” Optionally, if the feedstock is of a type that contains chemically-curable polymer binder, another step may be performed to further harden or “cure” the solidified feedstock by further causing an additional amount of cure of the curable polymer binder.

A debind step and a sintering step may be performed in a single apparatus (e.g., oven or furnace) or may be performed according to a sequence of a debind step performed in a first apparatus, and a subsequent sintering step being performed in a second (different) apparatus. A temperature used for a debind step is lower than a temperature used for a sintering step. A temperature for a thermal debind step may normally be in a range below 600 degrees Celsius, for example in a range from 100 to 550 or 600 degrees Celsius. A temperature selected of any particular debind step, of a particular multi-layer composite, can depend on the chemistry of the binder. A temperature for a sintering may be generally higher than a temperature for a debind step, e.g., greater than 550 or 600 degrees Celsius.

A useful or preferred debind step will remove ingredients of the binder composition from the inorganic particles, leaving behind only the inorganic particles. Example debind steps, referred to as “thermal debind” steps, expose the multi-layer composite to an elevated temperature that is sufficient to remove the ingredients of the binder composition from the multi-layer composite. Alternately or additionally, depending on the type of binder composition, a debind step may exposes the multi-layer composite to a chemical solvent that removes the ingredients of the binder composition from the multi-layer composite, which is referred to as a “chemical debind” step.

Following the debind step, the inorganic particles remain as a substantially residue-free porous body that includes substantially only the inorganic particles. Following a debind step, in the absence of a sintering step, the body may be in the form of the inorganic particles in an unfused, un-sintered state, but is self-supporting.

The body is processed by a sintering step. The term “sintering” as used herein to have a meaning that is consistent with the meaning that this term is given when used in the arts of porous sintered structures, such as porous sintered membranes of the type that may be used as a filter membrane. Consistent therewith, the term “sintering” can be used to refer to processes of bonding (e.g., “solid state welding” or “fusing”) together a collection of small, sinterable particles of one or more different types (sizes, compositions, shapes, etc.) by applying heat to the particles (i.e., to the precursor body) in a non-oxidizing environment so that surfaces of the particles reach a temperature that causes the particle surfaces to become fused together by a physical (mechanical) bond between the particles surfaces, but that does not cause the particles to melt (i.e., none of the metal materials reaches its melting temperature).

A sintering step is performed at a temperature that is above the sintering point of inorganic particles of the body, but below the melting temperature of the particles. As used herein, a “sintering point” of a particle is a temperature at which the material of the particle is capable of being sintered, i.e., a temperature at which particles of a body begin to adhere to other particles of the body, and adjacent particles can become fused together. A sintering point of a material (e.g., metal) is normally below a melting temperature of the material, meaning the temperature at which the particles become liquid.

Useful temperatures for performing a sintering step can depend on factors such as the size, shape, and composition of the inorganic particles. Different types, sizes, and shapes of particles may have different sintering points, and may require either a longer sintering period or a shorter sintering period (period of time held at a sintering temperature). Metal particles made of nickel, nickel alloy, stainless steel, and the like may typically have a sintering temperature in a range from about 550 about 1300 degrees Celsius. Ceramic particles made of alumina or zirconia and the like may typically have a sintering temperature in a range from about 1600 to about 2000 degrees Celsius. Particles made of refractory metals may typically have a sintering temperature in a range from about 1600 to about 2100 degrees Celsius.

Typical sintering periods may be in a range from 5 minutes to 60 minutes, depending on the particle material, particle size, and particle shape.

A sintering step can be performed in a furnace or oven and in a non-oxidizing atmosphere that will not react with or otherwise detrimentally affect the particles of the body being sintered, e.g., in a vacuum or in an atmosphere of concentrated or pure hydrogen, concentrated or pure inert gas, or a combination of concentrated or pure hydrogen and inert gas.

The porous body formed by an extrusion-type additive manufacturing technique is made using inorganic particles that are included in a feedstock composition, with other ingredients, to cause the particles to form a porous interconnected matrix during a sintering step. The particles are selected to exhibit physical properties, including morphology (including shape) and density properties, that allow the particles to be present as part of the solidified feedstock in a relatively low amount by volume, but to still become interconnected upon sintering.

Examples of useful particles for forming the porous sintered body can have a low “relative apparent density.” With a low “relative apparent density,” the particles can be present in a low volume percentage within feedstock and solidified feedstock as described, such as in an amount of less than 50 or 60 percent by volume based on total volume feedstock or solidified feedstock, while still being capable of being processed by sintering to form a self-supporting porous sintered body. With a low “relative apparent density,” the inorganic particles, even when present at a low percentage of the volume of the solidified feedstock, can still be capable of being effectively fused together by sintering to form a useful porous sintered body, e.g., a porous body that is “self-supporting,” made of fused interconnected particles, and, as one example, is useful as a filter membrane as described herein.

The inorganic particles, as a collection, have physical properties that include size, shape, and density that allow the particles to be distributed within a feedstock layer, and within solidified feedstock, at a relatively low volumetric amount, yet to be still processable by an extrusion-type additive manufacturing step and sintering to form a useful (e.g., interconnected and self-supporting) porous sintered body. A low volumetric amount of the particles in the solidified feedstock is desired so that a resultant sintered body exhibits a relatively high porosity, so that the sintered body can be effectively used as a porous filter membrane. Yet, even at a low volumetric amount in the solidified feedstock (to produce a high porosity sintered body), the particles contained in the solidified feedstock must have sufficient proximity between a sufficient amount of adjacent surfaces of the particles to become effectively fused and interconnected upon sintering, so that the particles that form the sintered body are highly interconnected and, therefore, the porous sintered body is self-supporting.

As used herein, a body that is “self-supporting” is a body that is capable of supporting its own weight during use, in a given form or shape, without collapsing and preferably without sagging to more than an insignificant degree. A porous sintered body as described herein that is self-supporting can be handled, moved, and optionally further processed, without the need for support from another structure such as a polymeric binder.

Specifically with respect to a self-supporting sintered body, a collection of inorganic particles can be formed into a porous sintered body that is self-supporting if the collection of metal particles includes a sufficiently high percentage of particles that are sufficiently close to each other within a feedstock, when extruded, to become fused together (i.e., “connected” or “interconnected”) upon being subsequently sintered as part of a precursor body. Preferably, a high percentage of inorganic particles of feedstock are located sufficiently close together, e.g., have at least one surface that contacts or nearly contacts at least one other metal particle surface, so that most or essentially all of the particles (e.g., 95, 99, or 99.9 percent of the total amount of particles) of the solidified feedstock become a fused particle of the porous sintered body. The high degree of contact or proximity (near contact) between particle surfaces can be present in a feedstock, a feedstock layer, solidified feedstock, and as part of a precursor body. The high degree of contact or proximity between the particle surfaces also remains during subsequent processing of the precursor body, such as during a debind step (to remove polymer from surfaces of particles of a multi-layer solidified feedstock composite) and during and after a sintering step.

A feedstock contains inorganic particles that as an ingredient or “raw material” are in the form of a collection of small particles, e.g., as a powder, with the particles being in any of various known particle forms such as particles referred to as “agglomerated particles,” dendritic particles,” or “fibrous particles,” among others.

The inorganic particles can be of any size or size range that is effective, including small or relatively small particles on a scale of microns (e.g., having an average size of less than 500 microns, less than 100 microns, less than 50 microns, 10 microns, or less than 5 microns).

Sizes and size distributions of a particles of a collection of particles, e.g., in the form of a dry powder, can be measured by various known measurement techniques, with certain techniques being used with particular types of particles. Particle sizes of particles that are generally spherical, e.g., having a low aspect ratio such as less than 5:1, may be effectively measured by laser diffraction methods. For irregularly-shaped particles such as fibrous particles, dendritic particles, or high aspect ratio particles, particle sizes may be assessed by visual methods that use microscopy equipment (e.g., a scanning electron microscope) to form an image of a sample of particles, and then visually or electronically determine particle sizes of particles in the sample from the image.

Some particles that are non-spherical may include multiple dimensions such as length, width, or dimensions of branches. According to certain types of feedstock and porous sintered bodies, particles of a feedstock can have at least one dimension that is smaller than other dimensions, such as a length, a width, a thickness, or a diameter. Example particles as described may have a smallest dimension that is less than 10 microns, or less than 5 microns. Examples of useful filament-type particles can have a width or thickness that is less than 10 microns, e.g., less than 5 microns, but may have a length of from 200 to 400 microns.

Optionally, a feedstock may contain a combination of two or more different types of particles, such as a combination of any two or more of: spherical particles, high aspect ratio particles, fibrous particles, and dendritic particles. Without limiting the present description, feedstocks that contain a combination of particle types may include: micron-scale particles (D50 in a range from 1 to 10 microns) in combination with nano scale particles (D50 in a range from 100 to 1000 nanometers); fibrous particles in combination with spherical particles; high aspect ratio particles in combination with spherical particles; or dendritic particles in combination with spherical particles.

The relative amounts of two different types of particles in a feedstock may be any amounts that are useful, such as relative amounts by weight in a range from 10 to 90 weight percent (a first particle type):90 to 10 weight percent (a second particle type), or 20 to 80 weight percent:80 to 20 weight percent, or 30 to 70 weight percent:70 to 30 weight percent, or from 40 to 60 weight percent:60 to 40 weight percent, based on total weight of the two types of particles in the combination (weight percent first particle type:weight percent second particle type), or from 5 to 50 weight percent:95 to 50 weight percent, or from 10 to 40 weight percent:90 to 60 weight percent, or from 15 to 30 weight percent:85 to 70 weight percent, based on total weight of the two types of particles in the combination.

Examples of feedstock having a combination of two or more different types of particles may have a bi-modal or tri-modal size distribution. An example powder may contain a bi-modal combination of micron-size particles and nano-size particles. A potential function and advantage of a powder that contains a combination of nano-size particles with micron-size particles may be improved formation of an interconnected particle matrix by sintering. The nano-size particles can facilitate sintering by acting as “necking agents” that connect the larger (micron-size) particles. A sintering step may occur at a lower temperature due the presence of the nano-size particles, and may optionally be performed using microwave energy.

Examples of inorganic particles that may be useful in a feedstock include inorganic particles that are metal or ceramic. Metal particles may contain (comprise, consist of, or consist essentially of) one or more different metals, either as a pure metal or as an alloy. The term “metal” as used herein refers to any metallic or metalloid chemical element or an alloy of two or more of these elements. Example metals include iron, refractory metals (e.g., tungsten, molybdenum, tantalum), titanium, and nickel. Examples of metal alloys include stainless steel, another iron or steel alloy, nickel alloys, titanium alloys, among others. Example ceramics include metal oxides, e.g., zirconia (ZrO₂), alumina (Al₂O₃), etc.

The inorganic particles can be selected to achieve effectiveness in processing as described, to be capable of being contained in a feedstock, formed into a feedstock layer, formed into solidified feedstock and a multi-layer solidified feedstock composite, and then sintered to form a porous sintered body. The size, shape, and chemical makeup of the inorganic particles can be any that are effective for these purposes. In some examples, inorganic particles that have been identified as being useful as described herein can be selected based on size, shape (including morphology), and density properties.

Density properties of the inorganic particles can be described as apparent density (a.k.a. bulk density), and as relative apparent density (apparent density divided by theoretical (or “particle” density)). Example particles made of nickel, nickel alloy, or stainless steel, measured in powder form, can have an apparent (“bulk”) density that is below 2 grams per cubic centimeter (g/cc), e.g., below 1.8 g/cc, or below 1.5 g/cc. Other materials may have higher density values (e.g., refractory metals) or lower apparent density values (e.g., certain ceramic materials). As is known, an apparent (bulk) density of a powder (collection of particles) refers to the mass of the powder for a given volume of the powder, with the volume including volume of the particles as well as volume of spaces between the particles in powder form. Methods for measuring apparent (bulk) density are well known, and include ASTM B703-17 “Standard Test Method for Apparent Density of Metal Powders and Related Compounds Using the Arnold Meter.”

Example metal particles in the form of a powder can also be selected to have a “relative apparent density” that allows for processing as described, to produce a porous sintered body by an extrusion-type additive manufacturing technique. As identified herein, particles can be selected based on relative apparent density to allow the particles to be successfully processed by extrusion to form a precursor body, and subsequent debinding and sintering to produce a porous sintered body having a desirably high porosity, sintered body containing particles that are interconnected and that form a self-supporting body. As used herein, and as commonly understood, the term “relative apparent density” is calculated as a ratio of an apparent density of a powder divided by a theoretical density of the powder. The theoretical density of a collection of particles (e.g., powder), also sometimes referred to as a “particle density” of the particles, refers to the density of the material (e.g., metal) that makes up the particles, e.g., the density (mass per volume) of a single particle, or a density of a collection of particles that is calculated based on weight per volume, with the volume calculated to include only the volume of the particles and not the volume of void space between the particles. Example inorganic particles that are useful according to methods as described can be in the form of a powder having a relative apparent density in a range from 5 to 50 percent of the theoretical density.

According to the present description, it has been determined that particles that exhibit a low “relative apparent density” can be processed by additive manufacturing steps to form a porous sintered body that has a high porosity and a correspondingly low solids loading, i.e., a low volume percent of the metal particles, such as below 50 percent (i.e., a high porosity). The low relative apparent density particles have physical shape and size properties that cause a high degree of contact or proximity between surfaces of the particles when included in solidified feedstock (even if present at a low amount (a low volume percent) in the solidified feedstock), with a high amount of space between particles. With a high degree of contact or proximity between the particle surfaces, even with a high void space, binder composition of the solidified feedstock can be removed and the inorganic particles can be processed by sintering to cause the particles to fuse together sufficiently at their surfaces to become interconnected and self-supporting, to form a useful porous sintered membrane.

A “relative apparent density” is a property of a collection of particles that can be directly affected by physical size and shape properties of the particles. Size and shape properties of powders made of inorganic particles (e.g., metal particles) can vary greatly, with known metal particles having many different shapes. Some examples of common particle shapes include those referred to as spherical, rounded, angular, flakey, cylindrical, acicular, cubic, columnar, dendritic, elongated, branched, or having a low or a high aspect ratio (the ratio of length to width of an elongated particle). Different types of inorganic particles may also be agglomerated or non-agglomerated, or “fibrous” or “filamentary” (“filament-type”). Certain types of particles, or branches or fibrils thereof, that have a predominant length dimension relative to small thickness and width dimensions can be characterized by as having a high aspect ratio.

Example inorganic particles can have shape and size features that cause the particles to exhibit a low relative apparent density, e.g., to form a collection of particles that as a powder includes a high level of void space between particles, e.g., a low packing density. Size and shape features of particles that have a low relative apparent density include features that cause a low packing density (“packing efficiency”). Shape features of particles that can produce low packing density (and high void space) include: irregular (non-geometric) shape features that include multiple fibrils or branches in random (non-repeating) arrangements between particles; an elongate shape of particles or portions of particles (e.g., a high aspect ratio); a high surface area; branching; twisted, bent, or curved filaments or branches; and the like that prevent close packing of the particles when the particles are part of a powder and that result in the presence of substantial void space between the particles.

Examples of particle shapes that can result in a low relative apparent density include shapes that are branched, shapes referred to as “dendritic,” and elongate (straight or bent or angular) shapes that are referred to as “fibrous” (or “filamentary”) or that exhibit a high aspect ratio.

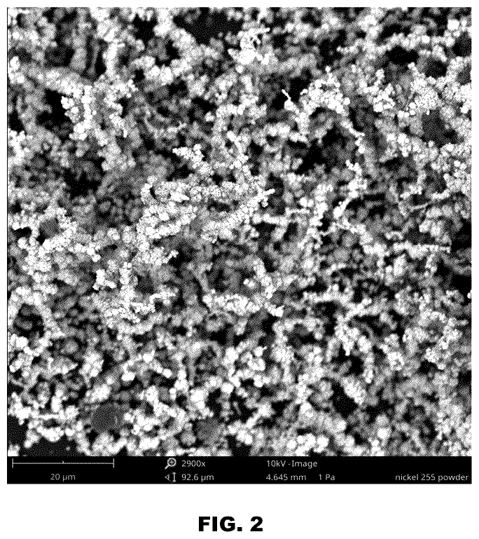

Dendritic metal particles include particles that have a dendritic morphology as described in U.S. Pat. No. 5,814,272. As presented therein, the term “dendritic” refers to a highly anisotropic, irregular morphology comprising one or more filaments individually having one dimension substantially greater than the other two dimensions of the filament. The filaments can be straight or bent and can also be branched or unbranched, with an irregular surface. Dendritic particles are characterized by low packing efficiencies compared to particles of more regular morphology and, therefore, form powders of lower apparent (bulk) density than those formed by particles of more regular morphology. Examples of dendritic particles include the Nickel 255 particles shown at FIG. 2.

Dendritic metal particles can be prepared and processed in a manner to cause the particles to achieve a desired dendritic morphology and a useful relative apparent density. Examples of processes useful for producing dendritic metal particles having density properties as described are presented in U.S. Pat. No. 5,814,272, the entirety of which is incorporated herein by reference. As explained therein, metal particles can be processed to have a relatively low “relative apparent density” by processing the particles to be dendritic. In general, effective processing methods may include steps of: (1) heating a powder comprising non-dendritic metal particles under conditions suitable to form a lightly sintered material; and (2) breaking the lightly sintered material to form a powder comprising dendritic metal particles.

The term “lightly sintered material” refers to a material that has been processed to cause fusion of metal powder particles through an initial stage of sintering, as defined by Randall (Randall in “Powder Metallurgy Science,” second edition, German, ed., Metal Powder Federation Industry (1994), the contents of which are incorporated herein by reference). In the initial stage of sintering, or short-range diffusional sintering, bonds form between metal particles at contacted particle surfaces, resulting in the fusion of the particles with their immediate neighbors only. Thus, the initial stage of sintering yields a brittle structure of low mechanical strength. For a given material, sintering proceeds slowly beyond this initial stage at temperatures at the lower end of the material's sintering range. For purposes of the present description, the term “initial stage sintering” refers to the sintering of a powder under conditions in which sintering does not proceed substantially beyond the initial stage.

FIG. 2 is a photomicrograph that shows dendritic particles made of Nickel 255 (an example of a commercially pure nickel metal powder).

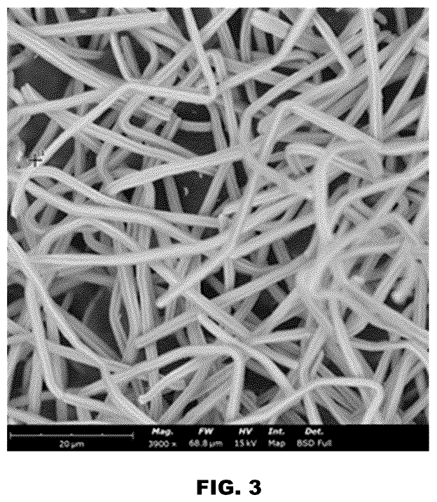

Another example of metal particles that are characterized by low packing efficiencies and a relatively low “relative apparent density” are particles referred to as “fibrous” or “filament-type” particles. Fibrous particles are elongated (e.g., “noodle-like”), optionally curved or bent, with a high aspect ratio, such as an aspect ratio (ratio of length to diameter) of at least 10:1 (length:diameter), at least 30:1, at least 50:1, or at least 75:1 or at least 100:1. Examples of fibrous metal particles include fibrous stainless steel particles such as those shown at FIG. 3.

Other types of metal particles in powder form, recognized as being non-dendritic and non-fibrous, are known and are also useful for preparing porous sintered bodies by sintering. These particles exhibit a relatively high packing efficiency compared to dendritic or fibrous particles and do not normally (without being combined with dendritic or fibrous particles) have a low relative apparent density. Examples of these types of particles include particles that are generally (substantially) unbranched, that have a relatively low aspect ratio (e.g., below 5:1 or below 3:1 or below 2:1), including particle types referred to as spherical, rounded, angular, flaked, cylindrical, acicular, and cubic.

A collection of particles useful in a method as described, in the form of a powder and having a low relative apparent density, may contain particles that all have substantially the same or comparable size, shape, and morphology, e.g., a collection of all dendritic particles, or a collection of all fibrous particles. Alternately, if desired, a collection of particles may contain a combination of two or more different types of metal particles that have different size, shape, or morphology features. Inorganic particles of a powder may include, for example, a combination of both dendritic particles and non-dendritic particles, or a combination of both fibrous particles and non-fibrous particles, etc., with the combination having a relative apparent density sufficient to be processed to form a porous sintered body, and precursors thereof, as described.

A collection of metal particles used in a feedstock can include one or more different types of metal particles. Examples of useful particle for a feedstock can include collections of particles that are made substantially or entirely of a single type of metal particles, e.g., a collection of particles made of at least 90, 95, 99, or 99.9 weight percent of one type of metal (including metal alloys) such as steel particles (e.g., stainless steel), nickel particles, nickel alloy particles, or particles made of another metal or metal alloy. Commercial examples include those sold under the following designations: Nickel 255, “Alloy 22” (Hastelloy® C-22), and 316L Stainless Steel.

Some nickel particles contain at least 99 percent by weight nickel based on total weight particles, with not more than a small amount of impurities such as carbon.

Other particles may be made of nickel alloys that contain a combination of nickel (e.g., from 45 to 56 weight percent), chromium (e.g., from 15 to 30 weight percent), and molybdenum (e.g., from 8 to 18 weight percent), along with lower amounts of metals such as iron, cobalt, tungsten, manganese, silicon, carbon, vanadium, and copper. A specific example of a nickel alloy referred to generically as nickel “alloy 22” (e.g., HASTELLOY® C-22®) contains (weight percent): nickel (56 Balance), chromium (22), molybdenum (13), iron (3), cobalt (2.5 max), tungsten (3), manganese (0.5 max), silicon (0.08 max), carbon (0.01 max), vanadium (0.35 max), and copper (0.5 max).

An example of a stainless steel alloy is Stainless Steel Alloy 316L, which can contain (weight percent): chromium (16-18), nickel (10-14), molybdenum (2-3), manganese (2.0 max), silicon (0.75 max), carbon (0.08 max), phosphorus (0.045 max), sulfur (0.30 max), nitrogen (0.10 max), and iron (balance).

Useful and preferred metal particles as described can have an apparent density and a relative apparent density as described, with particular metal alloys having characteristic density properties and characteristic combinations of density properties.

Useful or preferred stainless steel particles may have an apparent density in a range from 0.5 to 2 grams per cubic centimeter, e.g., from 0.8 to 1.2 grams per cubic centimeter, and a relative apparent density in a range from 5 to 25, e.g., from 7 to 20 percent of theoretical density.

Useful or preferred dendritic nickel particles may have an apparent density in a range from 0.3 to 1.5 grams per cubic centimeter, e.g., from 0.4 to 0.8 grams per cubic centimeter, and a relative apparent density in a range from 4 to 17 percent of theoretical density, e.g., from 5 to 9 percent of theoretical density.

Useful or preferred particles made of nickel alloy having high amounts (weight percent) of: nickel (e.g., from 45 to 56 weight percent), chromium (e.g., from 15 to 30 weight percent), and molybdenum (e.g., from 8 to 18 weight percent), such as Hastelloy® C-22, may have an apparent density in a range from 0.5 to 2 grams per cubic centimeter, e.g., from 1.2 to 1.8 grams per cubic centimeter, and a relative apparent density in a range from 5 to 13 percent of theoretical density, e.g., from 7 to 11 percent of theoretical density.

An amount of particles by volume in feedstock, solidified feedstock, or both, can be an amount that is useful to produce a porous sintered body as described herein, with a porosity as described. Examples, on a per total volume basis, can be in a range from 20 to 50 or 60 volume percent based on total volume solidified feedstock, e.g., from 25 to 45 percent.

A porous sintered body prepared according to a method as described may be useful as a filter membrane for filtering gases, e.g., gases used in semiconductor processing. Various features of porous sintered bodies are considered to affect the usefulness of the porous body as a filter membrane. In filtering gaseous materials for use in semiconductor processing, the gaseous fluid may be supplied at a pressure that is approximately atmospheric (e.g., under 2 atmospheres), above atmospheric pressure, or below atmospheric pressure (e.g. vacuum conditions). The process that uses the gaseous fluid may require a very high removal rate of nano-scale and micron-scale particles, e.g., at least 3, 4, 5, 7, or 9 as measured by “log reduction value” (LRV) of a filtering step. The process of filtering these gaseous materials also may be performed at relatively low flow-rates, e.g., below 50, 25, 10, 5, 2, 1, or 0.5 standard liters per minute (slpm) per square centimeter of frontal filter area. Methods as described herein can be useful to prepare filter membranes that meet requirements such as these, to allow the filter membrane to be used effectively as a filter membrane, for example for filtering a gaseous material for use in semiconductor processing.

Advantageously, a sintered porous body formed by an additive manufacturing method can be prepared to have any of a very large variety of three-dimensional shapes, including certain types of shapes that may not be possible to produce by previous techniques for forming porous bodies of the type useful as a filter membrane. Example shapes can be generally three-dimensional, including forms that are non-tubular (e.g., somewhat or substantially flat or planar), and forms that are tubular, which include a substantially annular or cylindrical forms or modifications thereof.

As used herein, a porous sintered body that is said to be formed by an additive manufacturing method may be structurally or physically identifiable as a body that has been produced by an additive manufacturing method, i.e., that includes a physical feature that is indicative of the body being formed by an additive manufacturing method. During additive manufacturing methods, a body is formed by multiple sequential steps of applying and solidifying multiple layers of feedstock to form solidified feedstock from each layer. Indications of the multiple layers of solidified feedstock may be visually identifiable after a sintering step, either with or without optical microscopy (e.g., at 50, 100, 200, or 500 times magnification). A particular feature that can be present as part of a porous sintered body of this description is a “staircase” effect or structure at surfaces of the porous sintered body. The multiple layers of the sintered body can be identified optically, e.g., using a microscope or scanning electron microscope, as an uneven, stratified surface that is produced by the multiple layers applied to form the precursor body giving the perception of a staircase structure being present on the surface, and that remains present through post-processing and may be detected as a feature of the pre-sintered body and the porous sintered body.

In a first aspect, a method of forming a porous sintered body by additive manufacturing, the method comprises: forming a solidified feedstock composite comprising layers of solidified feedstock, by: extruding feedstock that comprises inorganic particles and binder composition, forming a feedstock layer by applying the extruded feedstock to a surface, and causing the feedstock of the feedstock layer to solidify to form solidified feedstock; and forming an additional solidified feedstock layer to an upper surface of the solidified feedstock by extruding the feedstock and applying the feedstock to the upper surface; removing binder composition from the solidified feedstock composite; and heating the solidified feedstock composite to a temperature that causes inorganic particles of the solidified feedstock composite to become fused together to form a porous sintered body.

A second aspect according to the first aspect, wherein the porous sintered body has a porosity of at least 40 percent.

A third aspect according to any preceding aspect, wherein the feedstock comprises from 15 to 50 volume percent inorganic particles based on total volume of the feedstock.

A fourth aspect according to any preceding aspect, wherein the feedstock comprises from 80 to 95 weight percent inorganic particles based on total weight feedstock.

A fifth aspect according to any preceding aspect, wherein the inorganic particles have a smallest dimension below 10 microns.

A sixth aspect according to any preceding aspect, wherein the particles comprise a combination of two different particle types selected from: spherical particles, high aspect ratio particles, fibrous particles, and dendritic particles.

A seventh aspect according to any preceding aspect, wherein the inorganic particles are metal particles.

An eighth aspect according to the seventh aspect, wherein the metal particles are dendritic or fibrous.

A ninth aspect according to the seventh aspect, wherein the metal particles have an aspect ratio (length:diameter) of at least 100:1.

A tenth aspect according to any preceding aspect, wherein the binder composition comprises one or more of: thermoplastic polymer, thermosetting polymer, polymeric pore former particles, organic solvent distilled water.

An eleventh aspect according to any preceding aspect, wherein the binder composition comprises thermoplastic binder and the method comprises: heating the feedstock to a temperature above a melting temperature of the thermoplastic polymer to form heated feedstock, extruding the heated feedstock, and after extruding, allowing heated feedstock to cool to form the solidified feedstock.

A twelfth aspect according to the tenth aspect, wherein the binder composition comprises radiation-curable polymer and the method comprises exposing the feedstock to radiation to cause the feedstock to solidify to form solidified feedstock.

In a thirteenth aspect a porous sintered body prepared according to a method of any of the preceding aspects is disclosed.

In a fourteenth aspect, a method of forming a body by additive manufacturing, comprises: extruding feedstock that comprises binder composition and inorganic particles, the inorganic particles being present in an amount in a range from 15 to 50 percent by volume of the feedstock, applying the extruded feedstock to a surface to form a feedstock layer having an upper surface, causing the feedstock of the feedstock layer to solidify to form a solidified feedstock layer; and extruding the feedstock and applying the feedstock to the upper surface of the solidified feedstock layer to form an additional feedstock layer on the upper surface.

A fifteenth aspect according to the fourteenth aspect, wherein the feedstock comprises from 80 to 95 weight percent inorganic particles based on total weight feedstock.

A sixteenth aspect according to the fourteenth or fifteenth aspect, wherein the inorganic particles have a smallest dimension below 10 microns.

A seventeenth aspect according to any of the fourteenth through sixteenth aspects, wherein the particles comprise a combination of two different particle types selected from: spherical particles, high aspect ratio particles, fibrous particles, and dendritic particles.

An eighteenth aspect according to any of the fourteenth through seventeenth aspects, wherein the inorganic particles are metal particles.

A nineteenth aspect according to the eighteenth aspect, wherein the metal particles are dendritic or fibrous.

A twentieth aspect according to the eighteenth aspect, wherein the metal particles have an aspect ratio (length:diameter) of at least 100:1.

A twenty-first aspect according to any of the fourteenth through twentieth aspects, wherein the binder composition comprises one or more of: thermoplastic polymer, thermo-curable polymer, radiation-curable polymer, polymeric pore former particles, organic solvent, distilled water.

A twenty-second aspect according to any of the fourteenth through twenty-first aspects, wherein the binder composition comprises thermoplastic polymer and the method comprises: heating the feedstock to a temperature above a melting temperature of the thermoplastic polymer to form heated feedstock, extruding the heated feedstock, and after extruding, allowing the heated feedstock to cool to form solidified feedstock.

A twenty-third aspect according to any of the fourteenth through twenty-second aspects, wherein the binder composition comprises radiation-curable polymer and the method comprises exposing the feedstock layer to radiation to cause the feedstock layer to solidify.

A twenty-fourth aspect according to any of the fourteenth through twenty-third aspects, comprising: removing polymer from the solidified feedstock; and heating the solidified feedstock to a temperature that causes inorganic particles of the solidified feedstock to become fused together to form a porous sintered body.

In a twenty-fifth aspect, a porous sintered body prepared according to the method of twenty-fourth aspect is disclosed.

In a twenty-sixth aspect, a porous sintered body comprises: multiple layers of extruded inorganic particles fused together to form a porous matrix of interconnected inorganic particles, the porous sintered body having: layers having a thickness of from 30 to 200 microns, a porosity of at least 40 percent, and staircase structures on surfaces of the sintered porous bodies.

A twenty-seventh aspect according to the twenty-sixth aspect, wherein the inorganic particles comprise fibrous particles, high aspect ratio particles, or dendritic particles.

A twenty-eighth aspect according to the twenty-seventh aspect, comprising fused inorganic particles having a smallest dimension that is less than 10 microns.

A twenty-ninth aspect according to the twenty-eighth aspect comprising fused inorganic particles comprising a combination of two different particle types selected from: spherical particles, high aspect ratio particles, fibrous particles, and dendritic particles.

A thirtieth aspect according to any of the twenty-sixth through twenty-ninth aspects, wherein the inorganic particles are metal particles.

In a thirty-first aspect, feedstock capable of being processed by extrusion-type additive manufacturing, to form a porous sintered body is disclosed, the feedstock comprising binder composition and inorganic particles, the inorganic particles being present in an amount in a range from 15 to 50 percent by volume of the feedstock.

A thirty-second aspect according to the thirty-first aspect, wherein the inorganic particles have a smallest dimension below 10 microns.

A thirty-third aspect according to the thirty-first or thirty-second aspect, wherein the particles comprise a combination of two different particle types selected from: spherical particles, high aspect ratio particles, fibrous particles, and dendritic particles.

A thirty-fourth aspect according to any of the thirty-first through thirty-third aspects, wherein the inorganic particles are metal particles.

A thirty-fifth aspect according to the thirty-fourth aspect, wherein the metal particles are dendritic or fibrous.

A thirty-sixth aspect according to the thirty-fourth aspect, wherein the metal particles have an aspect ratio (length:diameter) of at least 100:1.

A thirty-seventh aspect according to any of the thirty-first through thirty-seventh aspects, wherein the binder composition comprises one or more of: curable polymer, pore former particles, and solvent.

1. A method of forming a porous sintered body by additive manufacturing, the method comprising:
forming a solidified feedstock composite comprising layers of solidified feedstock by:
extruding feedstock that comprises inorganic particles and binder composition,
forming a feedstock layer by applying the extruded feedstock to a surface,
causing the feedstock of the feedstock layer to solidify to form solidified feedstock; and
forming an additional solidified feedstock layer to an upper surface of the solidified feedstock by extruding the feedstock and applying the feedstock to the upper surface; removing binder composition from the solidified feedstock composite; and heating the solidified feedstock composite to a temperature that causes inorganic particles of the solidified feedstock composite to become fused together to form a porous sintered body.

2. The method of claim 1, wherein the porous sintered body has a porosity of at least 40 percent.

3. The method of claim 1, wherein the feedstock comprises from 15 to 50 volume percent inorganic particles based on total volume of the feedstock.

4. The method of claim 1, wherein the feedstock comprises from 80 to 95 weight percent inorganic particles based on total weight feedstock.

5. The method of claim 1, wherein the inorganic particles have a smallest dimension below 10 microns.

6. The method of claim 1, wherein the particles comprise a combination of two different particle types selected from: spherical particles, high aspect ratio particles, fibrous particles, and dendritic particles.

7. The method of claim 1, wherein the inorganic particles are metal particles.

8. The method of claim 7, wherein the metal particles are dendritic or fibrous.

9. The method of claim 7, wherein the metal particles have an aspect ratio (length:diameter) of at least 100:1.

10. The method of claim 1, wherein the binder composition comprises one or more of: thermoplastic polymer, thermosetting polymer, polymeric pore former particles, organic solvent distilled water.

11. A method of forming a body by additive manufacturing, the method comprising:
extruding feedstock that comprises binder composition and inorganic particles, the inorganic particles being present in an amount in a range from 15 to 50 percent by volume of the feedstock,
applying the extruded feedstock to a surface to form a feedstock layer having an upper surface,
causing the feedstock of the feedstock layer to solidify to form a solidified feedstock layer; and
extruding the feedstock and applying the feedstock to the upper surface of the solidified feedstock layer to form an additional feedstock layer on the upper surface.

12. The method of claim 11, wherein the feedstock comprises from 80 to 95 weight percent inorganic particles based on total weight feedstock.

13. The method of any claim 12, wherein the inorganic particles have a smallest dimension below 10 microns.

14. The method of claim 11, wherein the particles comprise a combination of two different particle types selected from: spherical particles, high aspect ratio particles, fibrous particles, and dendritic particles.

15. The method of claim 11, wherein the inorganic particles are metal particles.

16. The method of claim 15, wherein the metal particles are dendritic or fibrous.

17. The method of claim 15, wherein the metal particles have an aspect ratio of at least 100:1.

18. A porous sintered body comprising:
multiple layers of extruded inorganic particles fused together to form a porous matrix of interconnected inorganic particles, the porous sintered body having:
layers having a thickness of from 30 to 200 microns,
a porosity of at least 40 percent, and
staircase structures on surfaces of the sintered porous bodies.

19. The porous sintered body of claim 18, wherein the inorganic particles comprise fibrous particles, high aspect ratio particles, or dendritic particles.

20. The porous sintered body of claim 18, comprising fused inorganic particles having a smallest dimension that is less than 10 microns.

21. The porous sintered body of claim 18, comprising fused inorganic particles comprising a combination of two different particle types selected from: spherical particles, high aspect ratio particles, fibrous particles, and dendritic particles.

22. The porous sintered body of claim 18, wherein the inorganic particles are metal particles.
